(19) United States
(12) Patent Application Publication
(10) Pub. No.: US 2025/0305564 A1
(43) Pub. Date: Oct. 2, 2025

(54) Trailer Landing Gear Deployment Device

(71) Applicant: Sarah Ruiz-Mangi, Manteca, CA (US)

(72) Inventor: Sarah Ruiz-Mangi, Manteca, CA (US)

(21) Appl. No.: 18/620,806

(22) Filed: Mar. 28, 2024

(51) Int. Cl. F16H 21/12; B60S 9/04

(52) U.S. Cl. CPC F16H 21/12; B60S 9/04

(57) ABSTRACT

A trailer landing gear deployment device for mechanically raising and lowering a trailer includes a trailer and a landing gear that can be raised and lowered relative to the trailer. A handle is mechanically coupled to the landing gear, which is selectively raised and lowered by rotation of the handle. A disk is rotatably coupled to a housing. An arm is coupled to the disk. The arm is couplable to the handle and rotates the handle when the disk is rotated. A motor is operably coupled to the disk wherein the motor is actuatable to rotate the disk. A power source is electrically coupled to the motor. A control panel is electrically coupled to the power source. The control panel is manipulatable to actuate the motor.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to landing gears and more particularly pertains to a new landing gear for mechanically raising and lowering a trailer.

### (2) Description of Related Art Including Information Disclosed Under 37 CFR 1.97 and 1.98

The prior art relates to landing gears. Landing gears are a common piece of equipment on trailers and heavy equipment. For example, landing gear is used to selectively raise and lower a trailer, such as a semi-trailer. The landing gears can keep the trailer level once the trailer has been removed from the semi-tractor or other vehicle. Typically, a user needs to manually crank a handle attached to the landing gear to selectively raise or lower the landing gear. This process can be difficult, because the pieces of the landing gear and the trailer are large and heavy. This process can also be time consuming, because the user needs to physically stand next to the side of the trailer to turn the crank. Thus, there is a need for a device that can mechanically actuate the landing gear. Ideally, the device would be easily transported with the trailer, and would be compatible with existing trailers rather than being exclusively installed in new trailers.

### BRIEF SUMMARY OF THE INVENTION

An embodiment of the disclosure meets the needs presented above by generally comprising a trailer and a landing gear that is coupled to the trailer. The landing gear is configured to be raised and lowered relative to the trailer. A handle is mechanically coupled to the landing gear wherein the landing gear is selectively raised and lowered by rotation of the handle. A housing has a front wall, a top side, and a bottom side. A disk is rotatably coupled to the housing. An arm is coupled to the disk. The arm is releasably couplable to the handle wherein the arm rotates the handle when the disk is rotated. The arm may include a first shaft that extends outwardly from the disk and a second shaft that is coupled to the first shaft. A sleeve is coupled to and extends outwardly from the second shaft. The sleeve is hollow to receive the handle. A motor is operably coupled to the disk wherein the motor is actuatable to rotate the disk. A power source is electrically coupled to the motor. A control panel is electrically coupled to the power source. The control panel is manipulatable to actuate the motor.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a trailer landing gear deployment device according to an embodiment of the disclosure.

FIG. 2 is a front view of an embodiment of the disclosure.

FIG. 3 is a side view of an embodiment of the disclosure.

FIG. 4 is a top view of an embodiment of the disclosure.

FIG. 5 is an in-use view of an embodiment of the disclosure.

FIG. 6A is a block diagram view of an embodiment of the disclosure.

FIG. 6B is a block diagram view of an embodiment of the disclosure.

### DETAILED DESCRIPTION OF THE INVENTION

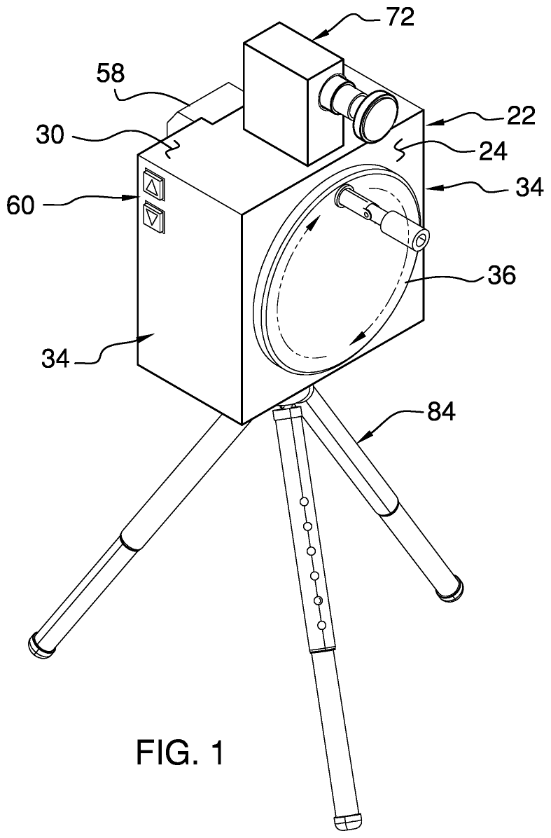

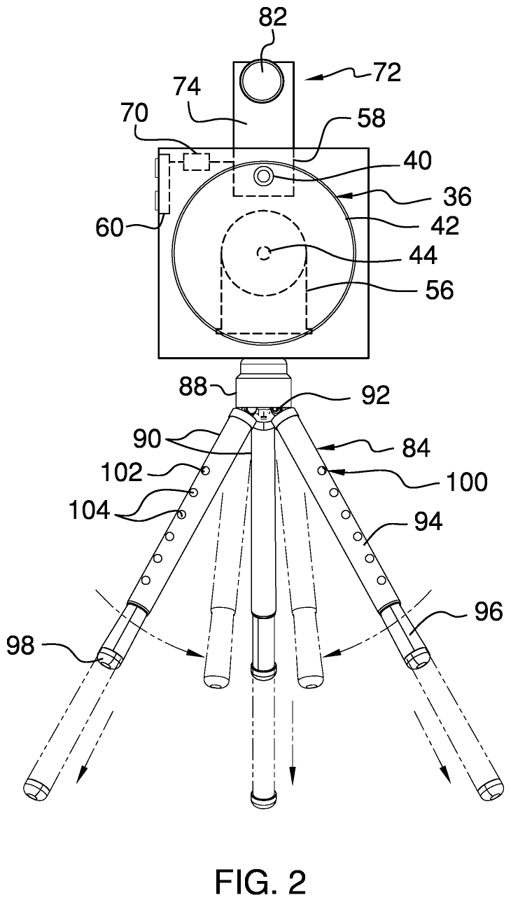

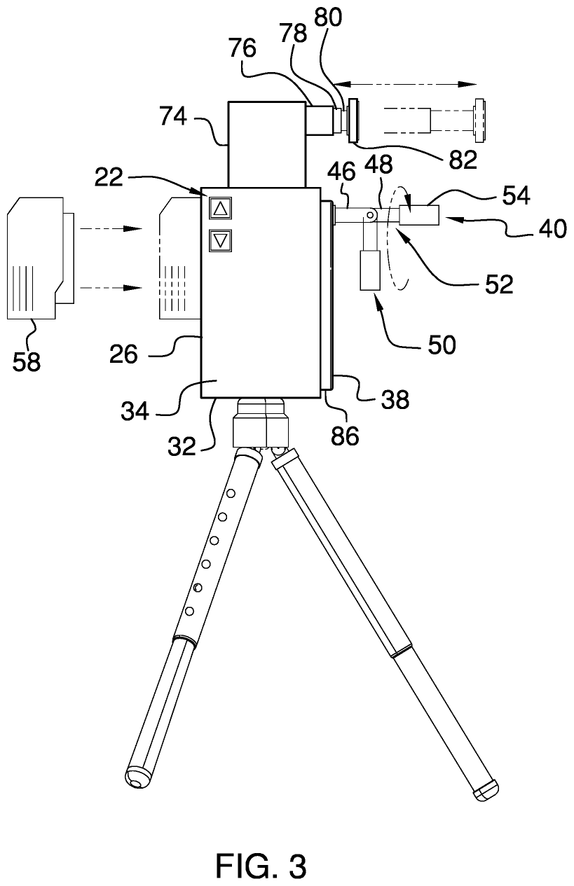

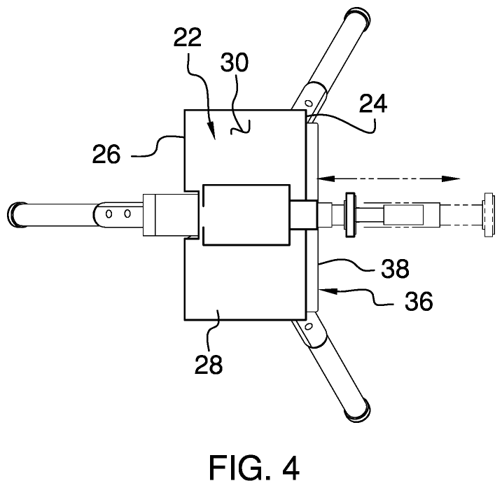

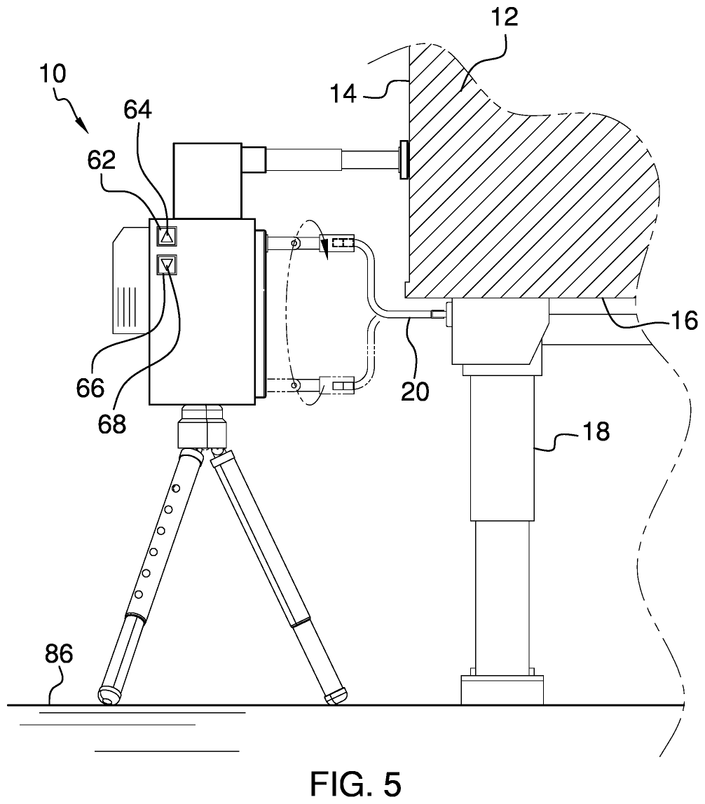

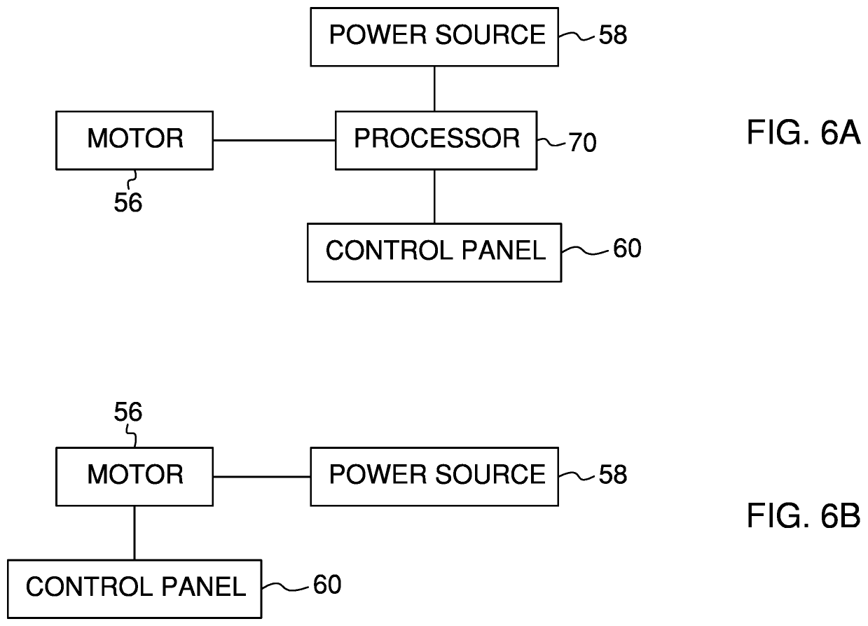

With reference now to the drawings, and in particular to FIGS. 1 through 6B thereof, a new landing gear embodying the principles and concepts of an embodiment of the disclosure and generally designated by the reference numeral 10 will be described.

As best illustrated in FIGS. 1 through 6B, the trailer landing gear deployment device 10 generally comprises a trailer 12 that generally has a side surface 14 that is coupled to and extends upwardly from a base surface 16. For example, the trailer 12 may be a semi-trailer. The side surface 14 may comprise a magnetically active material. A landing gear 18 is coupled to the trailer 12. For example, the landing gear 18 may be positioned on the base surface 16 of the trailer 12. The landing gear 18 is configured to be raised and lowered relative to the trailer 12. A handle 20 is mechanically coupled to the landing gear 18 wherein the landing gear 18 is selectively raised and lowered by rotation of the handle 20.

A housing 22 may have a front wall 24, a back wall 26, and a peripheral wall 28 that is coupled to and extends between the front wall 24 and the back wall 26. The peripheral wall 28 may have a top side 30, a bottom side 32, and a pair of lateral sides 34.

A disk 36 is coupled to the housing 22. The disk 36 is generally positioned on the front wall 24. For example, the disk 36 may be centrally positioned on the front wall 24. The disk 36 is rotatably coupled to the housing 22. For example, the disk 36 is rotatable on the front wall 24. The disk 36 may have a diameter between 1.5 feet and 3.5 feet. The disk 36 may extend outwardly from the front wall 24 of the housing 22 wherein a forward face 38 of the disk 36 is offset from the front wall 24 of the housing 22.

An arm 40 is coupled to the disk 36. The arm 40 is generally offset from a center of rotation 44 of the disk 36. For example, the arm 40 may be positioned proximate to a perimeter edge 42 of the disk 36. The arm 40 is couplable to the handle 20 wherein the arm 40 rotates the handle 20 when the disk 36 is rotated on the front wall 24. The arm 40 is thus configured to facilitate selectively raising and lowering the landing gear 18 for the trailer 12 without requiring a user to manually rotate the handle 20.

The arm 40 includes a first shaft 46 that extends outwardly from the disk 36. A second shaft 48 is coupled to the first shaft 46. The second shaft 48 may be pivotably coupled to the first shaft 46 wherein the second shaft 48 is pivotable downwardly toward the disk 36 into a storage position 50 and wherein the second shaft 48 is pivotable upwardly from the storage position 50 into a usage position 52. The second shaft 48 may be perpendicular to the first shaft 46 when the second shaft 48 is in the storage position 50. The second shaft 48 may be parallel to the first shaft 46 when the second shaft 48 is in the usage position 52. A sleeve 54 is coupled to and extends outwardly from the second shaft 48. The sleeve 54 is generally hollow to receive the handle 20 wherein the handle 20 is releasably couplable to the arm 40.

A motor 56 is operably coupled to the disk 36 wherein the motor 56 is actuatable to rotate the disk 36. For example, the motor 56 is actuatable to rotate the disk 36 in a first direction wherein the motor 56 is configured to facilitate the user in raising the landing gear 18 and the motor 56 is actuatable to rotate the disk 36 in a second direction wherein the motor 56 is configured to facilitate the user in lowering the landing gear 18.

A power source 58 is coupled to the housing 22. The power source 58 is electrically coupled to the motor 56. The power source 58 may be removably positionable on the back wall 26 of the housing 22. For example, the power source 58 may comprise a plurality of rechargeable batteries. The plurality of rechargeable batteries may include two or more rechargeable batteries such that a first rechargeable battery can be used while a second rechargeable battery is being recharged.

A control panel 60 is electrically coupled to the motor 56. The control panel 60 is manipulatable to actuate the motor 56. The control panel 60 may be positioned on a first lateral side of the pair of lateral sides 34 of the peripheral wall 28 of the housing 22. Embodiments of the control panel 60 may include a first button 62 and a second button 66 66. The first button 62 may have an upwardly pointed arrow 64, indicating that manipulation of the first button 62 actuates the motor 56 to rotate the disk 36 in the first direction and to raise the landing gear 18. The second button 66 may have a downwardly pointed arrow 68, indicating that manipulation of the second button 66 actuates the motor 56 to rotate the disk 36 in the second direction and to lower the landing gear 18.

Some embodiments may include a processor 70 that is electrically coupled to the motor 56 wherein the processor 70 actuates the motor 56. The processor 70 may be positioned within the housing 22. The processor 70 may be electrically coupled to the power source 58. The processor 70 may be electrically coupled to the control panel 60 wherein manipulation of the control panel 60 signals the processor 70 to actuate the motor 56.

A stabilization device 72 may be coupled to the housing 22. The stabilization device 72 is outwardly extendable past the front wall 24 of the housing 22 wherein the stabilization device 72 is configured to facilitate the user in positioning the housing 22 relative to the trailer 12 such that the arm 40 can be coupled to the handle 20.

For example, the stabilization device 72 may comprise a pedestal 74 that is coupled to and extends upwardly from the top side 30 of the peripheral wall 28 of the housing 22. The pedestal 74 may be centrally positioned on the top side 30. A post 76 is coupled to the pedestal 74. The post 76 extends outwardly from the pedestal 74, for example extending past the front wall 24 of the housing 22. The post 76 may be perpendicular to the pedestal 74.

A first rod 78 may be coupled to the post 76. The first rod 78 may be telescopically coupled to the post 76. For example, the first rod 78 may be nested within the post 76 wherein the first rod 78 is extendable relative to the post 76. The first rod 78 may be parallel to the post 76.

A second rod 80 may be coupled to the first rod 78. The second rod 80 may be telescopically coupled to the first rod 78. For example, the second rod 80 may be nested within the first rod 78 wherein the second rod 80 is extendable relative to the first rod 78. The second rod 80 may be parallel to the first rod 78.

A combined length of the first rod 78 and the second rod 80 may exceed a combined length of the first shaft 46 and the second shaft 48 of the arm 40 when the first rod 78 and the second rod 80 are each fully extended and when the second shaft 48 is in the usage position 52 wherein the stabilization device 72 is configured to facilitate the user in positioning the housing 22 relative to the trailer 12 such that the arm 40 can be coupled to the handle 20.

A plate 82 may be coupled to the second rod 80. The plate 82 may be magnetic. For example, the plate 82 may be magnetically engageable with the magnetically active material of the side surface 14 of the trailer 12 to releasably couple the stabilization device 72 to the trailer 12 wherein the stabilization device 72 is configured to stabilize a position of the housing 22 relative to the trailer 12.

A tripod 84 may be coupled to the housing 22 wherein the tripod 84 is configured to support the housing 22 above a ground surface 86. The tripod 84 may be positioned on the bottom side 32 of the peripheral wall 28 of the housing 22.

For example, the tripod 84 may include a hub 88 that extends downwardly from the bottom side 32 of the peripheral wall 28. The hub 88 may be centrally positioned on the bottom side 32. A plurality of legs 90 may be coupled to and extend downwardly from the hub 88.

Each leg of the plurality of legs 90 may include a joint 92 that is pivotably coupled to the hub 88 wherein each leg of the plurality of legs 90 is pivotable inwardly and outwardly relative to each other. A first leg member 94 may be coupled to and extend downwardly from the joint 92. A second leg member 96 may be coupled to the first leg member 94. For example, the second leg member 96 may be telescopically coupled to the first leg member 94. In such embodiments, the second leg member 96 may be nested within the first leg member 94 wherein the second leg member 96 is extendable relative to the first leg member 94.

A foot 98 may be coupled to the second leg member 94. The foot 98 may comprise a rubber material that is configured to increase friction between the ground surface 86 and the tripod 84 wherein the foot 98 is configured to stabilize a position of the housing 22 relative to the ground surface 86.

A retainer 100 may be engaged with the first leg member 94 and the second leg member 96 to releasably secure a position of the second leg member 96 relative to the first leg member 94. For example, the retainer 100 may comprise a detent 102 that is mounted on the second leg member 96 and that extends through one of a plurality of aligned apertures 104 extending through the first leg member 94.

In use, the housing 22 may be positioned next to the landing gear 18, such that the handle 20 is positioned within the sleeve 54 of the arm 40. The user may extend the first rod 78 and the second rod 80 of the stabilization device 72 to magnetically couple the plate 82 to the side surface 14 of the trailer 12, which stabilizes the position of the housing 22 relative to the trailer 12 and inhibits the housing 22 from moving while the arm 40 and the disk 36 rotate the handle 20. The control panel 60 may be manipulated to actuate the motor 56, which rotates in the first direction to raise the landing gear 18 and which rotates in the second direction to lower the landing gear 18.

When finished, the user may retract the first rod 78 and the second rod 80 of the stabilization device 72 and remove the handle 20 from the sleeve 54 of the arm 40. The second shaft 48 of the arm 40 may be pivoted downwardly into the storage position 50. To further facilitate storage and transport, each leg of the plurality of legs 90 may collapse by sliding the second leg member 96 upwardly into the first leg member 94. The plurality of legs 90 may also be pivoted inwardly toward each other using the joint 92.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A trailer landing gear deployment system comprising:
a trailer;
a landing gear being coupled to the trailer, the landing gear being configured to be raised and lowered relative to the trailer;
a handle being mechanically coupled to the landing gear wherein the landing gear is selectively raised and lowered by rotation of the handle;
a housing having a front wall, a top side, and a bottom side;
a disk being rotatably coupled to the housing;
an arm being coupled to the disk, the arm being releasably couplable to the handle wherein the arm rotates the handle when the disk is rotated, the arm including:
a first shaft extending outwardly from the disk;
a second shaft being coupled to the first shaft;
a sleeve being coupled to and extending outwardly from the second shaft, the sleeve being hollow to receive the handle;
a motor being operably coupled to the disk wherein the motor is actuatable to rotate the disk;
a power source being electrically coupled to the motor; and
a control panel being electrically coupled to the power source, the control panel being manipulatable to actuate the motor.

2. The trailer landing gear deployment system of claim 1, further comprising a tripod being coupled to the housing, the tripod being configured to support the housing above a ground surface.

3. The trailer landing gear deployment system of claim 2, the tripod further comprising:
a hub extending downwardly from the bottom side of the housing; and
a plurality of legs being coupled to and extending downwardly from the hub.

4. The trailer landing gear deployment system of claim 3, each leg of the plurality of legs further comprising:
a joint being pivotably coupled to the hub wherein each leg of the plurality of legs is pivotable inwardly and outwardly relative to each other;
a first leg member being coupled to and extending downwardly from the joint;
a second leg member being coupled to the first leg member;
a foot being coupled to the second leg member, the foot comprising a rubber material being configured to increase friction between the ground surface and the tripod wherein the foot is configured to stabilize a position of the housing relative to the ground surface.

5. The trailer landing gear deployment system of claim 4, wherein the second leg member is telescopically coupled to the first leg member, each leg of the plurality of legs further comprising a retainer being engaged with the first leg member and the second leg member to releasably secure a position of the second leg member relative to the first leg member.

6. The trailer landing gear deployment system of claim 5, wherein the second leg member is nested within the first leg member, the retainer further comprising a detent being mounted on the second leg member and extending through one of a plurality of aligned apertures extending through the first leg member.

7. The trailer landing gear deployment system of claim 1, wherein the disk is positioned on the front wall of the housing.

8. The trailer landing gear deployment system of claim 1, wherein the disk has a diameter between 1.5 feet and 3.5 feet.

9. The trailer landing gear deployment system of claim 1, wherein the disk extends outwardly from the front wall of the housing wherein a forward face of the disk is offset from the front wall of the housing.

10. The trailer landing gear deployment system of claim 1, wherein the second shaft of the arm is pivotably coupled to the first shaft wherein the second shaft is pivotable downwardly toward the disk into a storage position and wherein the second shaft is pivotable upwardly from the storage position into a usage position.

11. The trailer landing gear deployment system of claim 10, wherein the second shaft is perpendicular to the first shaft when the second shaft is in the storage position.

12. The trailer landing gear deployment system of claim 10, wherein the second shaft is parallel to the first shaft when the second shaft is in the usage position.

13. The trailer landing gear deployment system of claim 1, further comprising a stabilization device being coupled to the housing, the stabilization device extending outwardly past the front wall of the housing wherein the stabilization device is configured to facilitate a user in positioning the housing relative to the trailer such that the arm can be coupled to the handle.

14. The trailer landing gear deployment system of claim 13, the stabilization device further comprising:
a pedestal being coupled to and extending upwardly from the top side of the housing;
a post being coupled to the pedestal, the post extending outwardly from the pedestal;
a first rod being coupled to the post;
a second rod being coupled to the first rod;
a plate being coupled to the second rod, the plate being positionable against the trailer.

15. The trailer landing gear deployment system of claim 14, wherein the trailer comprises a magnetically active material, the plate being magnetic wherein the plate is magnetically engageable with the magnetically active material of the trailer to releasably couple the stabilization device to the trailer wherein the stabilization device is configured to stabilize a position of the housing relative to the trailer.

16. A trailer landing gear deployment system comprising:
a trailer having a side surface being coupled to and extending upwardly from a base surface, the side surface comprising a magnetically active material, the trailer being a semi-trailer;
a landing gear being coupled to the base surface of the trailer, the landing gear being configured to be raised and lowered relative to the trailer;
a handle being mechanically coupled to the landing gear wherein the landing gear is selectively raised and lowered by rotation of the handle;
a housing having a front wall, a back wall, and a peripheral wall being coupled to and extending between the front wall and the back wall, the peripheral wall having a top side, a bottom side, and a pair of lateral sides;
a disk being coupled to the housing, the disk being positioned on the front wall, the disk being centrally positioned on the front wall, the disk being rotatably coupled to the housing wherein the disk is rotatable on the front wall, the disk having a diameter between 1.5 feet and 3.5 feet, the disk extending outwardly from the front wall of the housing wherein a forward face of the disk is offset from the front wall of the housing;
an arm being coupled to the disk, the arm being positioned proximate to a perimeter edge of the disk wherein the arm is offset from a center of rotation of the disk, the arm being couplable to the handle wherein the arm rotates the handle when the disk is rotated on the front wall, the arm including:
a first shaft extending outwardly from the disk;
a second shaft being coupled to the first shaft, the second shaft being pivotably coupled to the first shaft wherein the second shaft is pivotable downwardly toward the disk into a storage position and wherein the second shaft is pivotable upwardly from the storage position into a usage position, the second shaft being perpendicular to the first shaft when the second shaft is in the storage position, the second shaft being parallel to the first shaft when the second shaft is in the usage position;
a sleeve being coupled to and extending outwardly from the second shaft, the sleeve being hollow to receive the handle wherein the handle is releasably couplable to the arm;
a motor being operably coupled to the disk wherein the motor is actuatable to rotate the disk, the motor being actuatable to rotate the disk in a first direction to raise the landing gear, the motor being actuatable to rotate the disk in a second direction to lower the landing gear;
a processor being electrically coupled to the motor wherein the processor actuates the motor, the processor being positioned within the housing;
a power source being coupled to the housing, the power source being electrically coupled to the processor, the power source being removably positionable on the back wall of the housing, the power source comprising a plurality of rechargeable batteries;
a control panel being electrically coupled to the processor, the control panel being manipulatable to actuate the motor, the control panel being positioned on a first lateral side of the peripheral wall of the housing, the control panel further comprising:
a first button having an upwardly pointed arrow, wherein manipulation of the first button actuates the motor to rotate the disk in the first direction;
a second button having a downwardly pointed arrow, wherein manipulation of the second button actuates the motor to rotate the disk in the second direction;
a stabilization device being coupled to the housing, the stabilization device being outwardly extendable past the front wall of the housing, the stabilization device comprising:
a pedestal being coupled to and extending upwardly from the top side of the peripheral wall of the housing, the pedestal being centrally positioned on the top side;
a post being coupled to the pedestal, the post extending outwardly from the pedestal past the front wall of the housing, the post being perpendicular to the pedestal;
a first rod being telescopically coupled to the post, the first rod being nested within the post wherein the first rod is extendable relative to the post, the first rod being parallel to the post;
a second rod being telescopically coupled to the first rod, the second rod being nested within the first rod wherein the second rod is extendable relative to the first rod, the second rod being parallel to the first rod;
a plate being coupled to the second rod, the plate being magnetic wherein the plate is magnetically engageable with the magnetically active material of the side surface of the trailer to releasably couple the stabilization device to the trailer wherein the stabilization device is configured to stabilize a position of the housing relative to the trailer;
a combined length of the first rod and the second rod exceeding a combined length of the first shaft and the second shaft of the arm when the first rod and the second rod are each fully extended and when the second shaft is in the usage position wherein the stabilization device is configured to facilitate a user in positioning the housing relative to the trailer such that the arm can be coupled to the handle;
a tripod being coupled to the housing, the tripod being positioned on the bottom side of the peripheral wall of the housing wherein the tripod is configured to support the housing above a ground surface, the tripod comprising:
a hub extending downwardly from the bottom side of the peripheral wall, the hub being centrally positioned on the bottom side;
a plurality of legs being coupled to and extending downwardly from the hub, each leg of the plurality of legs including:
a joint being pivotably coupled to the hub wherein each leg of the plurality of legs is pivotable inwardly and outwardly relative to each other;
a first leg member being coupled to and extending downwardly from the joint;
a second leg member being telescopically coupled to the first leg member, the second leg member being nested within the first leg member wherein the second leg member is extendable relative to the first leg member;
a foot being coupled to the second leg member, the foot comprising a rubber material being configured to increase friction between the ground surface and the tripod wherein the foot is configured to stabilize a position of the housing relative to the ground surface; and
a retainer being engaged with the first leg member and the second leg member to releasably secure a position of the second leg member relative to the first leg member, the retainer comprising:
a detent being mounted on the second leg member and extending through one of a plurality of aligned apertures extending through the first leg member.
